(19) United States
(12) Patent Application Publication
(10) Pub. No.: US 2022/0281750 A1
(43) Pub. Date: Sep. 8, 2022

(54) PROCESS FOR PURIFYING GRAPHITIC MATERIAL

(71) Applicant: COMMONWEALTH SCIENTIFIC AND INDUSTRIAL RESEARCH ORGANISATION, Australian Capital Territory (AU)

(72) Inventors: Karl BUNNEY, Australian Capital Territory (AU); Michael JACKSON, Australian Capital Territory (AU)

(21) Appl. No.: 17/635,261

(22) PCT Filed: Aug. 14, 2020
(86) PCT No.: PCT/AU2020/050849

§ 371 Date: Feb. 14, 2022

(30) Foreign Application Priority Data
Aug. 16, 2019 (AU) 2019902980

(51) Int. Cl. C01B 32/215

(52) U.S. Cl. CPC C01B 32/215; C01P 2006/80

(57) ABSTRACT

The present disclosure relates to a process for purifying graphitic material, in particular to achieve a high purity of >99.9% carbon (C). The process comprises a) heating a mixture of graphite and a eutectic mixture comprising two or more alkali metal hydroxides to produce a fused mass comprising the graphite and the eutectic mixture; b) leaching the fused mass with water or an aqueous solution to dissolve water-soluble impurities therein; and c) leaching the water-leached fused mass with an acidic solution to dissolve acid-soluble impurities therein, thereby producing high purity graphite.

### TECHNICAL FIELD

The present disclosure relates to a process for purifying graphitic material, in particular to achieve a high purity of >99.9% carbon (C).

### BACKGROUND

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Graphite has many industrial uses including, but not limited to, refractories, steelmaking, brake linings, foundry facings and lubricants. In the past thirty years there has been increasing demand for high purity graphite (>99.9% C) for use in battery electrodes.

Natural (mined) graphite is never present in the ground with the requisite purity, so purification processes must be applied in order to render the graphite sufficiently pure for industrial applications. As-mined graphite may be processed by flotation to produce a graphite concentrate before undergoing further purification.

There are two broad purification approaches applied to graphite concentrate—hydrometallurgical purification using either hydrogen fluoride or the “acid-base” method; or pyrometallurgical purification using extremely high temperature (>2700° C.) or a chlorination roasting method.

The “acid-base” method, also known as the alkali metal fusion method, is the most commonly used method and involves heating a mixture of graphite with sodium hydroxide at temperatures >300° C. to produce a fused mass, followed by successive leaching of the fused mass with water and acid.

The existing purification methods suffer from several drawbacks, including the use of toxic chemicals, such as hydrogen fluoride and chlorine, require high energy inputs (e.g. 300° C. <T<2700° C.) and/or do not meet the purity specifications of battery-grade graphite. Thus, there is a need to develop alternative and more efficient processes for purifying graphite to achieve a purity of >99.9% C.

### SUMMARY

The present inventors have undertaken research and development into processes for purifying graphite. In particular, the inventors have identified that heating a mixture of graphite and a eutectic mixture comprising at least one alkali metal hydroxide can produce a fused mass comprising the graphite which can then be subsequently leached to produce a high purity graphite, in particular to achieve a purity of >99.5% C, in particular >99.9% C, or even >99.95% C.

In a first aspect there is provided a process for purifying graphite comprising:

a) heating a mixture of graphite and a eutectic mixture comprising at least one alkali metal hydroxide to produce a fused mass;
b) leaching the fused mass with water or an aqueous solution to dissolve water-soluble impurities therein; and
c) leaching the water-leached fused mass with acid to dissolve acid-soluble impurities therein, thereby producing high purity graphite.

In some embodiments or examples, the process for purifying graphite comprises:

a) heating a mixture of graphite and a eutectic mixture comprising two or more alkali metal hydroxides to produce a fused mass comprising the graphite and the eutectic mixture;
b) leaching the fused mass with water or an aqueous solution to dissolve water-soluble impurities therein; and
c) leaching the water-leached fused mass with acid to dissolve acid-soluble impurities therein, thereby producing high purity graphite.

In some embodiments or examples, the fused mass may be leached with water in step b).

In other embodiments or examples, the fused mass may be leached with an aqueous solution in step b). The aqueous solution may be an alkaline solution. In some embodiments or examples, the leaching of the fused mass with water may produce an alkaline leachate. It will be appreciated by those skilled in the art that leaching the fused mass with water will dissolve at least a portion of the alkali from the fused mass, thereby producing the alkaline leachate. This alkaline leachate may be recycled and used in step b) to leach the fused mass. Accordingly, in one embodiment or example, the aqueous solution may be an alkaline leachate. For example, the fused mass may be leached with an alkaline leachate recycled from step b). Alternatively, the aqueous solution may be a wash liquor used to wash acid from the high purity graphite produced in step c).

In one embodiment or example, the eutectic mixture comprises at least a first alkali metal hydroxide and at least one alkali metal compound selected from a second alkali metal hydroxide and/or an alkali metal salt.

In one embodiment or example, the eutectic mixture may comprise at least a first alkali metal hydroxide and a second alkali metal hydroxide. In one example, the eutectic mixture may comprise two or more alkali metal hydroxides, such as sodium hydroxide and potassium hydroxide. In another embodiment, the eutectic mixture may comprise or consist of two alkali metal hydroxides, for example, selected from sodium hydroxide and potassium hydroxide. The eutectic mixture may comprise two alkali metal hydroxides having a molar ratio of about 10:1 to about 1:10; about 5:1 to about 1:5; about 3:1 to about 1:3; about 2:1 to about 1:2; or about 1:1. In one embodiment or example, the molar ratio of the first alkali metal hydroxide to the second alkali metal hydroxide in the eutectic mixture may be selected to provide a eutectic mixture which melts at or below the heating temperature at step a). In some embodiments or examples, the heating temperature at step a) may be less than about 300° C.

In an alternative embodiment, the eutectic mixture comprises at least one alkali metal hydroxide and one or more alkali metal salts. In one particular embodiment, the eutectic mixture may comprise sodium hydroxide and a sodium salt such as sodium nitrate or sodium nitrite. The eutectic mixture may comprise an alkali metal hydroxide and alkali metal salt having a molar ratio of about 10:1 to about 1:10; about 5:1 to about 1:5; about 3:1 to about 1:3; about 2:1 to about 1:2; or about 1:1. In one embodiment or example, the molar ratio of the alkali metal hydroxide to the alkali metal salt in the eutectic mixture may be selected to provide a eutectic mixture which melts at or below the heating temperature at step a). In some embodiments or examples, the heating temperature at step a) may be less than about 300° C.

Advantageously, the mixture of graphite and the eutectic mixture may form a fused mass at significantly lower temperatures than when graphite is mixed with an alkali hydroxide alone. In one embodiment, step a) may be performed at less than 300° C., less than 250° C., even less than 200° C. In some embodiments or examples, the mixture at step a) may be heated at a first temperature effective to produce a molten eutectic mixture and then heated to a second temperature effective to produce a fused mass comprising the graphite and the eutectic mixture. In some embodiments, the acid comprises a volatilisable acid. In some embodiments or examples, the acid has a boiling point of less than 300° C. at 1 atm, for example less than about 200° C.

In one embodiment or example, where the acid comprises a volatilisable acid, the process may further comprise:

d) distilling at least a portion of an acidic leachate produced in step c) to recover the volatilisable acid, and recycling said acid to step c).

In one embodiment, prior to step b) the process further comprises reacting the fused mass with a predetermined volume of water, thereby recovering thermal energy comprising sensible heat of the fused mass and heat of reaction between the fused mass and water. Advantageously, the recovered thermal energy may be utilised to generate steam for use as a heating stream, optionally in any one or more of steps a), b), c) or d).

### BRIEF DESCRIPTION OF DRAWINGS

Preferred embodiments will now be further described and illustrated, by way of example only, with reference to the accompanying drawings in which:

FIG. 1 is a representative flow sheet of one embodiment of the process for purifying graphite.

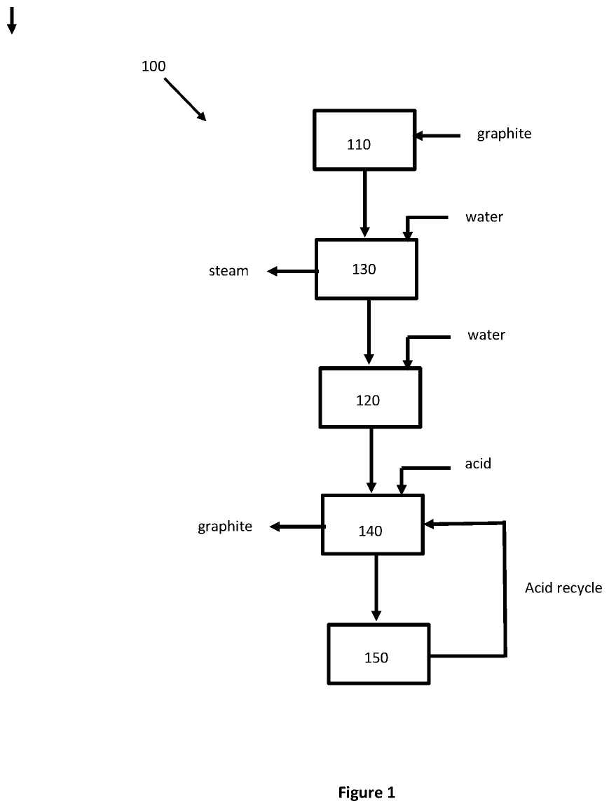

### DESCRIPTION OF EMBODIMENTS

The disclosure relates to a process for purifying graphite, in particular to achieve a purity of >99.5% C, in particular >99.9% C, or even >99.95% C.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

### Specific Terms

The term “graphite” as used herein refers to a naturally-occurring crystalline form of elemental carbon. Accordingly, the term ‘graphite’ encompasses high grade graphite ores and concentrates as well as medium to low grade ores, concentrates and blends thereof. The term encompasses all types of graphite, including flake graphite of various grades as well as processed forms of natural graphite such as spheronised natural graphite. High purity graphite refers to graphite with a purity of >99.5% C, in particular >99.9% C, or even >99.95% C.

The term “eutectic mixture” as used herein refers to a mixture of two or more components (e.g. ionic components) which usually do not react to form a new chemical compound but which inhibit the crystallisation process of one another thereby resulting in a system having a lower melting point than either of the components individually. The term as used herein does not refer exclusively to the minimum-melting composition, but includes it inter alia.

The term ‘alkali metal’ as used herein, particularly when used in conjunction with the term ‘hydroxide’ or ‘salt’ refers to monovalent cations of lithium, sodium, potassium, rubidium and caesium which occupy Group IA(1) of the periodic table.

The term ‘fused mass’ as used herein refers to a mixture comprising graphite and the eutectic mixture (comprising the least one alkali hydroxide) which has been heated to a temperature at which said eutectic mixture melts (also referred to as a molten system, e.g. a molten salt system) and then, optionally, allowed to at least partially solidify. It will be appreciated that the molten salt system, comprising the mixture of graphite and the eutectic mixture (as a melt) forming the fused mass, may not be considered a solution or an ‘aqueous solution’ because the molten salt system, and therefore the fused mass, may be substantially devoid of or free from water.

The term ‘aqueous solution’ as used herein refers to a solution in which the solvent is water and the solute may be an inorganic salt, an acid or a base. The water may be distilled water, deionised water, municipal water, fresh water, desalinated water, produced water, ground water, process water, recycled water, flowback water, brackish water, brine, salt water or seawater. The water may have an inherent total dissolved solids (TDS) content arising from the source of the water. Accordingly, it will be appreciated that the aqueous solution produced by dissolving the solute in water may include the solute in addition to the inherent TDS content of the water.

### Process for Purifying Graphite

As-mined graphite may be pre-treated by comminution to liberate the graphite grains from the host rock. The comminuted graphite may undergo an optional flotation process to produce a graphite concentrate having about >95% C. The flotation process may be any suitable flotation process as will be well understood by those skilled in the art. It will be appreciated that the particle size of the liberated graphite will vary depending on the mineralogy of the source rock. In some embodiments or examples, the process may not require any ultra-fine grinding of the graphite prior to heating with the eutectic mixture.

Referring to the accompanying FIGURE, the process (100) for purifying graphite may include heating (110) a mixture of graphite and a eutectic mixture comprising at least one alkali metal hydroxide to produce a fused mass.

The alkali metal hydroxide may be selected from a group comprising LiOH, NaOH, KOH, CsOH or RbOH.

The eutectic mixture may comprise two or more alkali metal hydroxides. Alternatively, the eutectic mixture may comprise an alkali metal hydroxide and one or more alkali metal salts. In some embodiments or examples, the eutectic mixture may comprise at least a first alkali metal hydroxide and at least one alkali metal compound selected from a second alkali metal hydroxide and/or an alkali metal salt. In one embodiment or example, the eutectic mixture comprises at least a first alkali metal hydroxide and a second alkali metal hydroxide. In another embodiment or example, the eutectic mixture may comprise two or more alkali metal hydroxides, such as sodium hydroxide and potassium hydroxide. For example, the eutectic mixture may comprise two alkali metal hydroxides selected from sodium hydroxide and potassium hydroxide. Further advantages are provided by the eutectic mixture comprising two or more alkali metal hydroxides in obtaining high purity graphite.

The alkali metal salt may be any suitable alkali metal salt capable of forming a eutectic mixture with the alkali metal hydroxide. The alkali metal salt may be an inorganic salt selected from a group comprising halides, carbonates, phosphates, nitrates, nitrites, sulphates, or sulphites. Alternatively, the alkali metal salt may be an organic salt selected from a group comprising acetate, oxalate, ascorbate, formate, citrate.

It will be appreciated by those skilled in the art that the two or more alkali metal hydroxides or the alkali metal hydroxide and the alkali metal salt(s) in the eutectic mixture may be combined in a suitable molar ratio whereby the melting temperature of the eutectic mixture may be substantially lowered in comparison to the melting temperature of any one of the respective components of the eutectic mixture.

Accordingly, the two alkali metal hydroxides in the eutectic mixture may have a molar ratio of about 10:1 to about 1:10; about 5:1 to about 1:5; about 3:1 to about 1:3; about 2:1 to about 1:2; or about 1:1.

Similarly, the molar ratio of the eutectic mixture comprising the alkali metal hydroxide and the alkali metal salt may be from about 10:1 to about 1:10; about 5:1 to about 1:5; about 3:1 to about 1:3; about 2:1 to about 1:2; or about 1:1.

The following table provides several suitable examples of eutectic mixtures (EM) comprising an alkali metal hydroxide (MOH) with either a different alkali metal hydroxide (M′OH) or an alkali metal salt (MX) which may be employed in the process as described herein.

| | Melting | | Melting | | Melting |
|---|---|---|---|---|---|
| | temper- | | temperature | Eutectic | temper- |
| | ature | | M′OH | mixture | ature |
| | MOH | M′OH | or MX | (MOH:M′OH | EM |
| MOH | (° C.) | or MX | (° C.) | or MX) | (° C.) |
| CsOH | 315 | CsNO₃ | 414 | 0.6 | 125 |
| CsOH | 315 | KOH | 406 | 0.57 | 175 |
| CsOH | 315 | NaOH | 323 | 0.5 | 153 |
| CsOH | 315 | LiOH | 471 | 0.76 | 275 |
| CsOH | 315 | RbOH | 301 | 0.6 | 290 |
| KOH | 406 | KBr | 734 | 0.72 | 295 |
| KOH | 406 | KI | 681 | 0.71 | 240 |
| KOH | 406 | KNO₃ | 334 | 0.32 | 215 |
| KOH | 406 | LiOH | 471 | 0.68 | 220 |
| KOH | 406 | NaOH | 323 | 0.48 | 165 |
| LiOH | 471 | LiBr | 550 | 0.43 | 260 |
| LiOH | 471 | LiCl | 610 | 0.65 | 270 |
| LiOH | 471 | LiI | 449 | 0.45 | 175 |
| LiOH | 471 | LiNO₃ | 261 | 0.40 | 180 |
| LiOH | 471 | NaOH | 323 | 0.30 | 210 |
| LiOH | 471 | RbOH | 301 | 0.25 | 235 |
| NaOH | 323 | Na₂CO₃ | 851 | 0.90 | 275 |
| NaOH | 323 | NaBr | 747 | 0.82 | 250 |
| NaOH | 323 | NaCl | 801 | ~0.9 | 300 |
| NaOH | 323 | NaI | 660 | 0.80 | 220 |
| NaOH | 323 | NaNO₃ | 307 | 0.29 | 250 |
| NaOH | 323 | Na₂SO₄ | 884 | 0.94 | 300 |
| NaOH | 323 | RbOH | 301 | 0.50 | 152 |
| RbOH | 301 | RbNO₃ | 310 | 0.63 | 140 |

Graphite may be mixed with the eutectic mixture in a weight ratio of from about 10:1 to about 1:10; about 2:1 to about 1:2; or about 1:1. Said weight ratio is with respect to dry solid weight of the eutectic mixture.

The graphite may be mixed with the eutectic mixture as a solid or a solution, such as an aqueous solution. In particular, a ‘wet’ mixture of graphite and the eutectic mixture is preferred to be fed to the heating step because of greater homogeneity in comparison to a ‘dry’ mixture of graphite and the eutectic mixture. Preferably, the ‘wet’ mixture contains sufficient water to form a paste-like mixture before heating. It will be appreciated by those skilled in the art that the volume of water employed should be selected to balance the ease of mixing the graphite and eutectic mixture against the amount of thermal energy subsequently required to volatilise the water and produce the fused mass. In other words, it will be appreciated that the ‘wet’ mixture of graphite and the eutectic mixture may not be considered a solution or an ‘aqueous solution’ because the volume of solution (e.g. aqueous solution) added to the ‘wet’ mixture to produce a paste-like mixture (e.g. slurry) such that the graphite may be effectively mixed with the eutectic mixture prior to heating step a).

In some embodiments or examples, step a) comprises heating an aqueous solution comprising the graphite and the eutectic mixture. The aqueous mixture comprising the graphite and the eutectic mixture may be referred to as the ‘wet’ mixture defined above. In some embodiments or examples, heating the ‘wet’ mixture comprising the graphite and the eutectic mixture may lead to one or more advantages, such as greater homogeneity in comparison to a ‘dry’ mixture of the graphite and the eutectic mixture, which can lead to higher purity and/or recovery. It will be appreciated that where the graphite and eutectic mixture is provided as a ‘wet’ mixture, any water or aqueous liquid present in the solution may be volatilised during heating step a) to produce the fused mass.

In some embodiments or examples, the aqueous solution may comprise at least about 5, 10, 15, 20, 30, 40, 50, or 60% w/w graphite based on the total weight of the solution. In some embodiments or examples, the aqueous solution may comprise less than about 60, 50, 40, 30, 20, 15, 10 or 5% w/w graphite based on the total weight of the solution. Combinations of these % w/w values are also possible, for example between about 5% w/w to about 50% w/w, or about 10% w/w to about 40% w/w to about graphite based on the total weight of the solution.

In some embodiments or examples, the aqueous solution may comprise at least about 20, 30, 40, 50, 60, 70, 80, or 90% w/w eutectic mixture based on the total weight of the solution. In some embodiments or examples, the aqueous solution may comprise less than about 90, 80, 70, 60, 50, 40, 30, or 20% w/w eutectic mixture based on the total weight of the solution. Combinations of these % w/w values are also possible, for example between about 20% w/w to about 70% w/w, about 30% w/w to 50% w/w eutectic mixture based on the total weight of the solution.

In some embodiments or examples, the aqueous solution may comprise at least about 20, 30, 40, 50, 60, 70, or 80% w/w water or aqueous liquid based on the total weight of the solution. In some embodiments or examples, the aqueous solution may comprise less than about 80, 70, 60, 50, 40, 30 or 20% w/w water or aqueous liquid based on the total weight of the solution. Combinations of these % w/w values are also possible, for example between about 20% w/w to about 80% w/w, about 30% w/w to 60% w/w water or aqueous liquid based on the total weight of the solution.

In some embodiments or examples, the aqueous solution may comprise between about 5% w/w to about 50% w/w graphite, between about 20% w/w to about 70% w/w eutectic mixture, and between about 20% w/w to about 80% w/w water, based on the total weight of the solution. In some embodiments or examples, the aqueous solution may comprise between about 10% w/w to about 40% w/w graphite, between about 30% w/w to about 50% w/w eutectic mixture, and between about 30% w/w to about 60% w/w water, based on the total weight of the solution.

The heating step may be performed in a heating crucible or any other suitable heating vessel. Advantageously, the mixture of graphite and the eutectic mixture may be heated to form a fused mass at significantly lower temperatures than when graphite is mixed with a single alkali metal hydroxide alone.

The heating step may be a temperature effective to melt the eutectic mixture (e.g. to produce a molten eutectic mixture) and may be a temperature effective to produce a fused mass. In one embodiment or example, the heating may be performed at a temperature effective to substantially volatilise water from the mixture, and then to melt the eutectic mixture and produce a fused mass comprising the graphite and the eutectic mixture. In another embodiment or example, the heating may be at a temperature of less than about 300° C. to produce a fused mass comprising the graphite and the eutectic mixture. In one embodiment, the heating step may be performed at less than 300° C., less than 250° C., even less than 200° C. The reference to “substantially” volatilise water generally refers to the water becoming volatile such that only trace amounts of water may be present in the mixture, for example this may be an amount by weight % in the total mixture of less than about 5%, 4%, 3%, 2%, 1%, 0.1%, 0.01%, 0.001%, or 0.0001%.

In some embodiments or examples, the mixture at step a) may be heated at a first temperature effective to substantially volatilise water from the mixture and then heated to a second temperature effective to produce a melt the eutectic mixture and thereby produce the described fused mass comprising the graphite and the eutectic mixture. It will be appreciated that the first temperature and second temperature may be the same. For example, the process for purifying graphite may comprise or consist of a)(i) heating the mixture of graphite and the eutectic mixture comprising two or more alkali metal hydroxides to a first temperature to substantially volatilise water from the mixture and then (ii) heating said mixture to a second temperature to melt the eutectic mixture and produce a fused mass comprising the graphite and the eutectic mixture.

For step a)(i) the temperature may be in a range between about 120° C. and about 250° C. The temperature for step a)(i) may be at least about 120, 130, 140, 150, 160, 170, 180, 190, 200, 210, 220, 230, 240 or 250° C. The temperature for step a)(i) may be less than about 250, 240, 230, 220, 200, 190, 180, 170, 160, 150, 140, 130 or 120° C. Combinations of these heating temperatures are also possible, for example between about 120° C. to about 250° C., about 130° C. to about 240° C., or about 140° C. to about 200° C., to volatilise water. It will be appreciated that other temperatures are envisaged, provided the temperature of the mixing at step a)(i) is effective to volatilise water.

For step a)(ii) the temperature may be in a range between about 160° C. and about 300° C. The temperature for step a)(ii) may be at least about 160, 170, 180, 190, 200, 210, 220, 230, 240, 250, 260, 270, 280, 290 or 300° C. The temperature for step a)(ii) may be less than about 300, 290, 280, 270, 260, 250, 240, 230, 220, 200, 190, 180, 170 or 160° C. Combinations of these heating temperatures are also possible, for example between about 160° C. to about 300° C., about 170° C. to about 280° C., or about 180° C. to about 260° C., to melt the eutectic mixture and produce a fused mass comprising the graphite and the eutectic mixture. It will be appreciated that other temperatures are envisaged, provided the temperature of the mixture at step a)(ii) is effective to melt the eutectic mixture and produce a fused mass comprising the graphite and the eutectic mixture.

At least according to some embodiments or examples as described herein, the mixture (e.g. ‘wet’ mixture) may be maintained at the temperature in step a)(i) for about 30 minutes to about 180 minutes. The mixture may be maintained at the temperature of step a)(i) for at least for at least 30, 60, 70, 80, 90, 100, 110, 120, 130, 140, 150, 160, 170 or 180 minutes. The mixture may be maintained at the temperature of step a)(i) for less than 180, 170, 160, 150, 140, 130, 120, 110, 100, 90, 80, 70, 60 or 30 minutes. Combinations of these times are also possible, for example between about 60 minutes and about 150 minutes.

At least according to some embodiments or examples as described herein, the mixture (e.g. ‘wet’ mixture) may be maintained at the temperature in step a)(ii) for about 120 minutes to about 300 minutes. The mixture may be maintained at the temperature of step a)(ii) for at least for at least 120, 140, 160, 180, 200, 220, 240, 260, 280 or 300 minutes. The mixture may be maintained at the temperature of step a)(ii) for less than 300, 280, 260, 240, 220, 200, 180, 160, 140 or 120 minutes. Combinations of these times are also possible, for example between about 120 minutes and about 240 minutes.

At least according to some embodiments or examples as described herein, the mixture may be pre-heated to the temperature for step a)(i) at a rate of about 2° C./minute to about 15° C./minute, about 4° C./minute to about 12° C./minute, or about 6° C./minute to about 10° C./minute. The mixture may be pre-heated to the temperature for step a)(i) at a rate of less than about 15° C./minute, less than about 12° C./minute, less than about 10° C./minute, less than about 8° C./minute, less than 6° C./minute, or less than 4° C./minute. The mixture may be pre-heated to the temperature for step a)(i) at a rate of at least about 4° C./minutes, at least about 6° C./minutes, at least about 8° C./minutes, at least about 10° C./minutes, or at least about 12° C./minutes. The mixture may be pre-heated to the temperature step a)(i) at a rate that may be provided in a range between any two of these previously described upper and/or lower values.

As according to some embodiments or examples as described herein, the mixture may be heated to the temperature for step a)(ii) at a rate of about 2° C./minute to about 15° C./minute, about 4° C./minute to about 12° C./minute, or about 6° C./minute to about 10° C./minute. The mixture may be heated to the temperature for step a)(ii) at a rate of less than about 15° C./minute, less than about 12° C./minute, less than about 10° C./minute, less than about 8° C./minute, less than 6° C./minute, or less than 4° C./minute. The mixture may be heated to the temperature for step a)(ii) at a rate of at least about 4° C./minutes, at least about 6° C./minutes, at least about 8° C./minutes, at least about 10° C./minutes, or at least about 12° C./minutes. The mixture may be heated to the temperature step a)(ii) at a rate that may be provided in a range between any two of these previously described upper and/or lower values.

The fused mass may then be leached (120) with water or an aqueous solution to dissolve water-soluble impurities therein. The water-soluble impurities include, but are not limited to, silicate and aluminate minerals. The leachate may contain some dissolved eutectic mixture. Consequently, the leachate may be concentrated and recycled and combined with graphite in step a). The leachate may be concentrated by any conventional technique known to those skilled in the art, such as by evaporation, reverse osmosis, vacuum distillation, multi-effect evaporator, and so forth.

In some embodiments or examples, the fused mass formed in step a) may be cooled to ambient temperature prior to leaching in step b).

In an alternate embodiment or example, the fused mass formed in step a) may be cooled to a leaching temperature prior to leaching in step b). The fused mass formed in step a) may be cooled to a leaching temperature for step b) in a range between about 50° C. and about 120° C. The leaching temperature for step b) may be at least about 50, 60, 70, 80, 90, 100 or 120° C. The leaching temperature for step b) may be less than about 120, 100, 90, 80, 70, 60 or 50° C. Combinations of these leaching temperatures are also possible, for example between about 60° C. to about 110° C., or about 80° C. to about 100° C.

The leaching at step b) may be performed for a suitable period of time. At least according to some embodiments or examples as described herein, the fused mass may be maintained at the leaching temperature in step b) for about 1 hour to about 48 hours. The fused mass may be maintained at the leaching temperature of step b) for at least for at least about 1, 2, 4, 10, 12, 18, 20, 24, 36 or 48 hours. The fused mass may be maintained at the leaching temperature of step b) for less than about 48, 36, 24, 20, 18, 12, 10, 4, 2 or 1 hours. Combinations of these leaching times are also possible, for example between about 1 hour to about 46 hours, or about 12 hours to about 36 hours.

Prior to leaching the fused mass with water (120) or an aqueous solution, in some embodiments, the process may be adapted to recover the sensible heat retained by the fused mass after the heating step (110). For example, the fused mass may be reacted (130) with a pre-determined volume of water to generate steam for use as a heating stream in various process steps in the present process or in a plant where the present process is deployed. Advantageously, as the reaction between water and the alkali metal hydroxide is exothermic, the heat of reaction may be additionally recovered (at the same time), also as steam.

The heating stream may be used to pre-heat the eutectic mixture or graphite before they are mixed, or to pre-heat the mixture of graphite and the eutectic mixture prior to step a). Alternatively, the heating stream may be used to generate electrical power in a steam turbine.

The pre-determined volume of water or aqueous solution has a weight ratio from about half as much water or aqueous solution as the mass of eutectic mixture to about five times as much water or aqueous solution as the mass of eutectic mixture, more preferably about an equal mass of water or aqueous solution as the eutectic mixture.

It will be appreciated that the pre-determined volume of water or aqueous solution is relatively small in comparison to the fused mass—too large a volume of water or aqueous solution would absorb the sensible heat of the fused mass and heat of reaction rather than produce steam. In this step, a small volume of an alkaline solution of the eutectic mixture will be produced, which may be recycled and combined with graphite in step a). Alternatively, the alkaline solution of the eutectic mixture may be recycled and used in step b) to remove water-soluble impurities from the fused mass.

After removing the water-soluble impurities from the fused mass, the fused mass may be leached (140) with acid to dissolve acid-soluble impurities therein and produce a high purity graphite. The acid-soluble impurities include, but are not limited to, carbonates (e.g. calcite and dolomite), iron oxides, and base metal oxides.

The acid may be a volatilisable acid. For example, the acid may be HCl or HNO₃. In one embodiment or example, the acid may have a boiling point of less than about 200° C. at a pressure of 1 atm (101.325 kPa). In one embodiment or example, the acid does not comprise sulfuric acid.

The acid may have a suitable concentration. The acid may have a concentration of at least about 1, 2, 3, 4, 5, 6, 7, 8, 9 or 10 M. The acid may have a concentration of less than about 10, 9, 8, 7, 6, 5, 4, 3, 2, or 1 M. Combinations of these molar concentrations are also possible, for example between about 2 M to about 7 M.

The leaching at step c) may be performed at a suitable temperature. In some embodiments or examples, the water-leached fused mass formed in step b) may be heated to a leaching temperature for step c) to produce a high purity graphite. The water-leached fused mass formed in step b) may be heated to a leaching temperature for step c) in a range between about 50° C. and about 120° C. to produce a high purity graphite. The leaching for step c) may be at a temperature of at least about 50, 60, 70, 80, 90, 100 or 120° C. The leaching for step c) may be at a temperature of less than about 120, 100, 90, 80, 70, 60, or 50° C. to produce a high purity graphite. Combinations of these leaching temperatures are also possible, for example between about 50° C. to about 120° C., e.g. about 70° C. to about 100° C.

The leaching at step c) may be performed for a suitable period of time. At least according to some embodiments or examples as described herein, the water-leached fused mass may be maintained at the leaching temperature in step c) for about 1 hour to about 48 hours to produce a high purity graphite. The water-leached fused mass may be maintained at the leaching temperature of step b) for at least for at least about 1, 2, 4, 10, 12, 18, 20, 24, 36 or 48 hours to produce a high purity graphite. The water-leached fused mass may be maintained at the leaching temperature of step b) for less than about 48, 36, 24, 20, 18, 12, 10, 4, 2 or 1 hours. Combinations of these leaching times are also possible, for example between about 1 hour to about 46 hours, or about 12 hours to about 36 hours to produce a high purity graphite.

The resulting high purity graphite may be filtered from the acidic leachate. At least a portion of the acidic leachate may be distilled (150) to recover the volatilisable acid so that it can be recycled to the leaching step (140). In this way, the recovered volatilisable acid may be free of the acid-soluble impurities which dissolve in the acid during the leaching step (140). It is envisaged that steam derived as described above may be used in the distillation of the volatisable acid.

It will be apparent that the process as described herein has several advantages:
Combining a eutectic mixture comprising at least one alkali metal hydroxide with graphite allows the conventional alkali bake step to be performed at a significantly lower temperature than a conventional alkali bake using sodium hydroxide alone, thereby providing energy savings and potentially capital expenditure reductions associated with using materials of construction for lower temperature conditions.
The recovery of sensible heat of the fused mass and heat of reaction of the eutectic mixture with water also provides energy savings in the form of recovery/conservation of thermal heat and the application of the recovered thermal heat in other process steps e.g. distillation of acidic leachate, pre-heating of graphite, re-concentration of leachate, etc.
The recovery and recycling of acid through distillation, leading to a reduction in reagent consumption and lowered operational expenditure.

### EXAMPLES

The invention is further illustrated by the following examples. The examples are provided for illustrative purposes only. It is not to be construed as limiting the scope or content of the invention in any way.

### Example 1

Graphite concentrate (10 g), assayed 97.8% pure, was mixed with KOH (11.2 g) and NaOH (8.0 g), and sufficient water was added to form a mixable paste. The paste was heated to 250° C. over 2 hours in an open crucible, and maintained at 250° C. for 4 hours.

After cooling, the fused mass was dissolved in water and the solids in 35% HNO₃ (approximately 8 M) (50 mL) boiling under reflux for 3 hours. The solids were filtered, washed and dried. The filtered graphite was assayed 99.94% pure.

### Example 2

Graphite concentrate (10 g), assayed 97.8% pure, was mixed with NaOH (5 g), KOH (7 g) and water (10 g). The resulting paste was heated to 200° C. over 2.5 hours, then heated to 250° C. and maintained at that temperature for 2 hours.

After cooling, the fused mass was leached with water (approx. 100 mL) at room temperature for 1 hour, then filtered. The filtered solids were leached with 20% HNO₃ (approximately 5 M) (100 mL) at 80° C. for 24 hours.

The solids were filtered, washed with water, and dried. The filtered graphite was assayed 99.97% pure.

### Example 3

Graphite concentrate (4.06 g), assayed 96.8% pure, was mixed with NaOH (3.93 g), KOH (5.65 g) and water (9.8 g). The resulting slurry was heated to 140° C. over 1 hour, then to 180° C. and maintained at 180° C. for 2 hours.

The fused mass was leached with water (80 mL) at 90° C. for 20 hours, then filtered. The solids were washed with water, and leached with 16% hydrochloric acid (approximately 5 M) (80 mL) at 90° C. for 20 hours. The solids were recovered by filtration, washed with water, and dried. The filtered graphite assayed 99.94% pure.

### Example 4

Graphite concentrate (4.0 g), assayed 96.9% pure, was mixed with NaOH (4.0 g), KOH (5.6 g), and water (17 g). The resulting slurry was heated to about 150° C. over 1 hour, then to 200° C. and maintained at 200° C. for 2 hours.

The fused mass was leached with water (20 mL) at 90° C. for 24 hours, then filtered. The solids were washed with water, and leached with 4 M hydrochloric acid (80 mL) at 90° C. for 24 hours. The solids were recovered by filtration, washed with water, and dried. The filtered graphite assayed 99.96% pure.

All purities referred to in the above Examples were determined by analysing samples by XRF, and subtracting the measured concentrations of impurities expressed as oxides from the totality

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A process for purifying graphite comprising:
a) heating a mixture of graphite and a eutectic mixture comprising two or more alkali metal hydroxides to produce a fused mass comprising the graphite and the eutectic mixture;
b) leaching the fused mass with water or an aqueous solution to dissolve water-soluble impurities therein; and
c) leaching the water-leached fused mass with an acidic solution to dissolve acid-soluble impurities therein, thereby producing high purity graphite.

2. The process according to claim 1, wherein the eutectic mixture comprises two alkali metal hydroxides selected from sodium hydroxide and potassium hydroxide.

3. The process according to claim 1, wherein the eutectic mixture comprises two alkali metal hydroxides having a molar ratio of about 10:1 to about 1:10, or about 3:1 to about 2:1, or about 1:1.

4. The process according to claim 1, wherein the eutectic mixture further comprises one or more alkali metal salts.

5. The process according to claim 1, wherein the mixture at step a) is heated to a first temperature effective to substantially volatilise water from the mixture and then heated to a second temperature effective to melt the eutectic mixture and produce a fused mass comprising the graphite and the eutectic mixture.

6. The process according to claim 1, wherein the acid at step c) comprises a volatilisable acid.

7. The process according to claim 6, further comprising:
d) distilling at least a portion of an acidic leachate produced in step c) to recover the volatilisable acid, and recycling said acid to step c).

8. The process according to claim 1, wherein prior to step b) the process further comprises reacting the fused mass with a predetermined volume of water, thereby recovering thermal energy comprising sensible heat of the fused mass and heat of reaction between the fused mass and water.

9. The process according to claim 8, wherein the recovered thermal energy is utilised to generate steam for use as a heating stream in any one or more of steps a), b), c) or d).
